(19) United States
(12) Patent Application Publication
(10) Pub. No.: US 2025/0131313 A1
(43) Pub. Date: Apr. 24, 2025

(54) QUANTUM BIT CONTROL SIGNAL DELAY CALIBRATION METHOD AND RELATED DEVICE

(71) Applicant: YANGTZE DELTA INDUSTRIAL INNOVATION CENTER OF QUANTUM SCIENCE AND TECHNOLOGY, Suzhou (CN)

(72) Inventors: Tian LUAN, Suzhou (CN); Yansong GAO, Suzhou (CN); Bo FAN, Suzhou (CN); Baojun LU, Suzhou (CN); Chengxin LI, Suzhou (CN)

(21) Appl. No.: 19/002,756

(22) Filed: Dec. 27, 2024

Related U.S. Application Data
(63) Continuation of application No. PCT/CN2024/070286, filed on Jan. 3, 2024.

(30) Foreign Application Priority Data
May 8, 2023 (CN) 202310505832.8

(51) Int. Cl. G06N 10/40

(52) U.S. Cl. CPC G06N 10/40

(57) ABSTRACT

The present application discloses a quantum bit control signal delay calibration method and a related device, which are applied to the technical field of signal calibration, and include: sampling the trigger signal at a signal receiving end at a preset sampling interval to obtain a sampling value; the trigger interval being an integral multiple of the sampling interval; counting effective sampling values in each trigger interval, comparing the number of the effective sampling values corresponding to each trigger interval with a nominal value, counting the number of fuzzy trigger intervals inconformity with the nominal value in a plurality of trigger intervals, and recording it as a sampling fuzzy severity; after the sampling fuzzy severity is recorded once, adjusting sampling time of the sampling according to a preset delay step length, to obtain the sampling fuzzy severity corresponding to a plurality of delay values, and generating a fuzzy severity quantization sequence.

### CROSS-REFERENCE TO RELATED APPLICATIONS

The present application is a continuation of International Application No. PCT/CN2024/070286, with an international filing date of Jan. 3, 2024, which is based upon and claims priority to Chinese Patent Application No. 202310505832.8, filed on May 8, 2023, the entire contents of all of which are incorporated herein by reference.

### TECHNICAL FIELD

The present disclosure relates to a technical field of signal calibration, particularly to a quantum bit control signal delay calibration method, a quantum bit control signal delay calibration device, a quantum bit control signal delay calibration equipment and a computer-readable storage medium.

### BACKGROUND

Superconducting quantum bit is one of the main forms of quantum bits, which is widely used in the field of quantum computing, quantum communication, etc. The state of each superconducting quantum bit needs to be controlled by signals, and the coordinate position of the quantum bit in the X/Y/Z axes is controlled, the process of which is known as quantum bit control. In the modern superconducting quantum system, the number of bits has exceeded 20 bits, and the total number of the corresponding control signals is more than 60 channels. As these quantum bits need to act synchronously to realize the quantum entanglement characteristics, the required multi-channel control signals must be synchronized strictly, and the control signals shall be output synchronously under the action of the same trigger signal, which has a very high requirement for synchronous triggering.

Trigger signals, when used, are generally sampled using a fixed-frequency clock within an FPGA (Field Programmable Gate Array) of a user end generated by control signal. Once the switch from “0 level” to “1 level” is sampled, the user end considers that a trigger is coming, and then performs the subsequent control signal generation processing. When the user end uses the clock to sample the trigger signal, the delay from each channel of trigger signal to the user end will be inconsistent due to the influence of the cable, connector and PCB routing that transmit the trigger signal, and there is a certain possibility that the edge of the trigger signal is sampled, i.e., the edge of switching between “0 level” and “1 level”. This will lead to sampling ambiguity, and may result in false triggering, causing asynchronous multi-channel triggering, thus causing a large synchronization error in the output of multi-channel control signals. The error time is usually a cycle of the sampling clock, which is unacceptable in quantum bit control. Accordingly, how to avoid sampling ambiguity in the sampling process is an urgent problem to be solved by those skilled in the art.

### SUMMARY

The present disclosure aims at providing a quantum bit control signal delay calibration method, which can effectively avoid the occurrence of sampling ambiguity. The present disclosure further aims at providing a quantum bit control signal delay calibration device, a quantum bit control signal delay calibration equipment and a computer-readable storage medium, which can effectively avoid the occurrence of sampling ambiguity.

In order to solve the above problem, the present disclosure provides a quantum bit control signal delay calibration method, comprising:
obtaining a multi-channel trigger signal; the trigger signal being a signal sent sequentially according to a uniform trigger interval;
sampling the trigger signal at a signal receiving end at a preset sampling interval to obtain a sampling value; the trigger interval being an integral multiple of the sampling interval;
counting effective sampling values in each trigger interval, comparing the number of the effective sampling values corresponding to each trigger interval with a nominal value, counting the number of fuzzy trigger intervals inconformity with the nominal value in a plurality of trigger intervals, and recording it as a sampling fuzzy severity;
after the sampling fuzzy severity is recorded once, adjusting sampling time of the sampling according to a preset delay step length, circularly executing the steps from sampling the trigger signal at the signal receiving end at a preset sampling interval to adjusting the sampling time according to the preset delay step length to obtain the sampling fuzzy severity corresponding to a plurality of delay values, and generating a fuzzy severity quantization sequence; and
determining an actual delay value corresponding to each channel of the trigger signal from a normal interval of the fuzzy severity quantization sequence, and correcting the trigger signal according to the actual delay value.

Alternatively, obtaining a multi-channel trigger signal comprises:
obtaining a multi-channel trigger signal output by a variable delay fan-out chip based on an original trigger signal;
correcting the trigger signal according to the actual delay value comprises:
solidifying the actual delay value to the variable delay fan-out chip, and correcting the trigger signal.

Alternatively, the nominal value is equal to the number of samples in the trigger interval.

Alternatively, counting effective sampling values in each trigger interval comprises:
obtaining a sampling value in each trigger interval; and
comparing the sampling value with the predicted value, taking the successfully compared sampling value as an effective sampling value, and counting the effective sampling value in each trigger interval; the sampling value which is not successfully compared being a sampling value obtained by sampling an edge of the trigger signal.

Alternatively, adjusting sampling time of the sampling according to a preset delay step length, circularly executing the steps from sampling the trigger signal at the signal receiving end at a preset sampling interval to adjusting the sampling time according to the preset delay step length to obtain the sampling fuzzy severity corresponding to a plurality of delay values, and generating a fuzzy severity quantization sequence comprises:
delaying the sampling time of the sampling according to the preset delay step length, circularly executing the steps from sampling the trigger signal at the signal receiving end at a preset sampling interval to delaying the sampling time according to the preset delay step length until the current delay value is equal to the sampling interval, to obtain the sampling fuzzy severity corresponding to a plurality of delay values, and generating a fuzzy severity quantization sequence.

Alternatively, determining an actual delay value corresponding to each channel of the trigger signal from a normal interval of the fuzzy severity quantization sequence comprises:
determining a normal interval between two deterioration intervals in the fuzzy severity quantization sequence as a required normal interval; the sampling fuzzy severity corresponding to the delay value in the deterioration interval being greater than a standard value, and the sampling fuzzy severity corresponding to the delay value in the normal interval being not greater than a standard value; and
determining an actual delay value corresponding to each channel of the trigger signal from the required normal interval.

Alternatively, determining an actual delay value corresponding to each channel of the trigger signal from the required normal interval comprises:
selecting the delay value closest to the central position in the required normal interval as the actual delay value.

The present disclosure further provides a quantum bit control signal delay calibration device, comprising:
a trigger signal module for obtaining a multi-channel trigger signal; the trigger signal being a signal sent sequentially according to a uniform trigger interval;
a sampling module sampling the trigger signal at a signal receiving end at a preset sampling interval to obtain a sampling value; the trigger interval being an integral multiple of the sampling interval;
a statistical module for counting effective sampling values in each trigger interval, comparing the number of the effective sampling values corresponding to each trigger interval with a nominal value, counting the number of a fuzzy trigger interval inconformity with the nominal value in a plurality of trigger intervals, and recording it as a sampling fuzzy severity;
a delay module for adjusting sampling time of the sampling according to a preset delay step length after the sampling fuzzy severity is recorded once, circularly operating the sampling module to the delay module to obtain the sampling fuzzy severity corresponding to a plurality of delay values, and generating a fuzzy severity quantization sequence; and
a calibration module for determining an actual delay value corresponding to each channel of the trigger signal from a normal interval of the fuzzy severity quantization sequence, and correcting the trigger signal according to the actual delay value.

The present disclosure further provides quantum bit control signal delay calibration equipment, comprising:
a memory for storing a computer program; and
a processor for implementing the steps of a quantum bit control signal delay calibration method according to any one of the above steps when executing the computer program.

The present disclosure further provides a computer-readable storage medium, the computer-readable storage medium having a computer program stored thereon, the computer program being executed by a processor to implement the steps of a quantum bit control signal delay calibration method according to any one of the above steps.

The quantum bit control signal delay calibration method provided by the present disclosure comprises: obtaining a multi-channel trigger signal; the trigger signal being a signal sent sequentially according to a uniform trigger interval; sampling the trigger signal at a signal receiving end at a preset sampling interval to obtain a sampling value; the trigger interval being an integral multiple of the sampling interval; counting effective sampling values in each trigger interval, comparing the number of the effective sampling values corresponding to each trigger interval with a nominal value, counting the number of fuzzy trigger intervals inconformity with the nominal value in a plurality of trigger intervals, and recording it as a sampling fuzzy severity; after the sampling fuzzy severity is recorded once, adjusting sampling time of the sampling according to a preset delay step length, circularly executing the steps from sampling the trigger signal at the signal receiving end at a preset sampling interval to adjusting the sampling time according to the preset delay step length to obtain the sampling fuzzy severity corresponding to a plurality of delay values, and generating a fuzzy severity quantization sequence; and determining an actual delay value corresponding to each channel of the trigger signal from a normal interval of the fuzzy severity quantization sequence, and correcting the trigger signal according to the actual delay value.

After sampling a trigger signal having a fixed trigger interval based on a fixed sampling interval, an effective sampling value in each trigger interval is firstly counted, the number of fuzzy trigger intervals is counted, and recorded as a sampling fuzzy severity; then the delay of the sampling signal is adjusted, and a fuzzy severity quantization sequence is generated based on the recorded sampling fuzzy severity under each delay, thus determining an actual delay value corresponding to each channel of the trigger signal, and correcting the trigger signal. In the process of adjusting the delay of the sampling signal, it will inevitably sweep over the edge of the trigger signal, and thus will inevitably undergo a process of “deterioration-normal-deterioration-normal” or “normal-deterioration-normal-deterioration”. In the above process, the actual delay value corresponding to each channel of trigger signal is determined from the normal interval of the fuzzy severity quantization sequence, so that the occurrence of the sampling ambiguity can be effectively avoided, and the accuracy of multi-channel sampling signals can be effectively improved.

The process includes counting the number of fuzzy trigger intervals inconformity with the nominal value in a plurality of trigger intervals, and recording it as a sampling fuzzy severity; and further obtaining the sampling fuzzy severity corresponding to a plurality of delay values through delay, and generating a fuzzy severity quantization sequence. By referring to the specific conditions of a plurality of trigger interval, it will be possible to minimise accuracy problems caused by measurement errors or operational errors from a statistical point of view. Meanwhile, the fuzzy severity quantization sequence obtained from further measurement by the sampling fuzzy severity can accurately reflect the real condition of the measurement signal channel, so as to obtain a more accurate actual delay value, effectively avoid the occurrence of the sampling amiguity, and effectively improve the accuracy of multi-channel sampling signals.

The present disclosure further provides a quantum bit control signal delay calibration device, a quantum bit control signal delay calibration equipment and a computer-readable storage medium, which can achieve the above advantageous effects, and thus will not be described in detail herein.

### BRIEF DESCRIPTION OF THE DRAWINGS

In order to more clearly explain the technical solutions in the embodiments of the present disclosure or the prior art, drawings required in the embodiments or the prior art will be briefly described below. Obviously, the drawings in the following description are some embodiments of the present disclosure. For those skilled in the art, other drawings may be obtained from these drawings without any creative effort.

FIG. 1 is a flow diagram of a quantum bit control signal delay calibration method provided by an embodiment of the present disclosure;

FIG. 2 is a structural diagram of the system corresponding to FIG. 1;

FIG. 3 is a schematic structural diagram of a variable delay fan-out chip of FIG. 2;

FIG. 4 is a schematic diagram of the principle corresponding to FIG. 1;

FIG. 5 is a flow diagram of a specific quantum bit control signal delay calibration method provided by an embodiment of the present disclosure;

FIG. 6 is a schematic diagram of a fuzzy severity quantization sequence;

FIG. 7 is a schematic diagram of a specific principle provided by an embodiment of the present disclosure;

FIG. 8 is a schematic diagram of a specific fuzzy severity quantization sequence provided by an embodiment of the present disclosure;

FIG. 9 is a structural block diagram of a quantum bit control signal delay calibration device provided by an embodiment of the present disclosure;

FIG. 10 is a structural block diagram of a quantum bit control signal delay calibration equipment provided by an embodiment of the present disclosure.

### DETAILED DESCRIPTION OF THE EMBODIMENTS

The core of the present disclosure is to provide a quantum bit control signal delay calibration method. In the prior art, there are two main methods for synchronous triggering. The first method is to generate multi-channel trigger signals directly through an external pulse delay signal generator, wherein the delay of each output trigger pulse signal is independently adjustable and applied to each user end. The disadvantages of this method are: due to a large number of control signals, a correspondingly large number of external trigger signals are required, and the number of the output signals from the external pulse delay signal generator is limited, which is generally 4 channels, and the cost is difficult to control. In addition, a problem of synchronization exists among a plurality of pulse delay signal generators, further increasing the difficulty of synchronous calibration. When each channel of the trigger signal output by the external pulse delay signal generator is used at the user end, the problem of sampling ambiguity also exists. However, because the external pulse delay signal generator and the user end are independent from each other, it is more complicated to solve the sampling ambiguity of each trigger signal.

The second method is to use a single trigger signal in the form of a “one-to-multiple” and connect it to the user end, avoiding sampling ambiguity by adjusting the sampling clock phase. Because the sampling clock is related to all subsequent signal processing, it is not simple to adjust the clock phase of each control signal. In addition, modern signal processing circuits have a large variety and number of clocks, and thus the adjustment of the phase of each clock is too costly and technically complex. Since the sampling clock is the basis of the digital processing of the control signal, the uncertainty of the clock also makes it difficult to automatically calibrate the sampling ambiguity within the FPGA.

In the quantum bit control signal delay calibration method provided by the present disclosure, after sampling a trigger signal having a fixed trigger interval based on the fixed sampling interval, the effective sampling value in each trigger interval is firstly counted, the number of fuzzy trigger intervals is counted, and recorded as a sampling fuzzy severity; then the delay of the sampling signal is adjusted, a fuzzy severity quantization sequence is generated based on the recorded sampling fuzzy severity under each delay, thus determining an actual delay value corresponding to each channel of the trigger signal, and correcting the trigger signal. In the process of adjusting the delay of the sampling signal, it will inevitably sweep over the edge of the trigger signal, and thus will inevitably undergo a process of “deterioration-normal-deterioration-normal” or “normal-deterioration-normal-deterioration”. In the process, an actual delay value corresponding to each channel of trigger signal is determined from the normal interval of the fuzzy severity quantization sequence, so that the occurrence of the sampling ambiguity can be effectively avoided, and the accuracy of multi-channel sampling signals can be effectively improved.

The process includes counting the number of fuzzy trigger intervals inconformity with the nominal value in a plurality of trigger intervals, and recording it as a sampling fuzzy severity; and further obtaining the sampling fuzzy severity corresponding to a plurality of delay values through delay, and generating a fuzzy severity quantization sequence. By referring to the specific conditions of a plurality of trigger interval, it will be possible to minimise accuracy problems caused by measurement errors or operational errors from a statistical point of view. Meanwhile, the fuzzy severity quantization sequence obtained by further measuring the sampling fuzzy severity can accurately reflect the real condition of the measurement signal channel, so as to obtain a more accurate actual delay value, effectively avoid the occurrence of the sampling fuzzy, and effectively improve the accuracy of multi-channel sampling signals.

In order to more clearly explain the technical solutions in the embodiments of the present disclosure or the prior art, drawings required in the embodiments or the prior art will be briefly described below. Obviously, the drawings in the following description are some embodiments of the present disclosure. For those skilled in the art, other drawings may be obtained from these drawings without any creative effort.

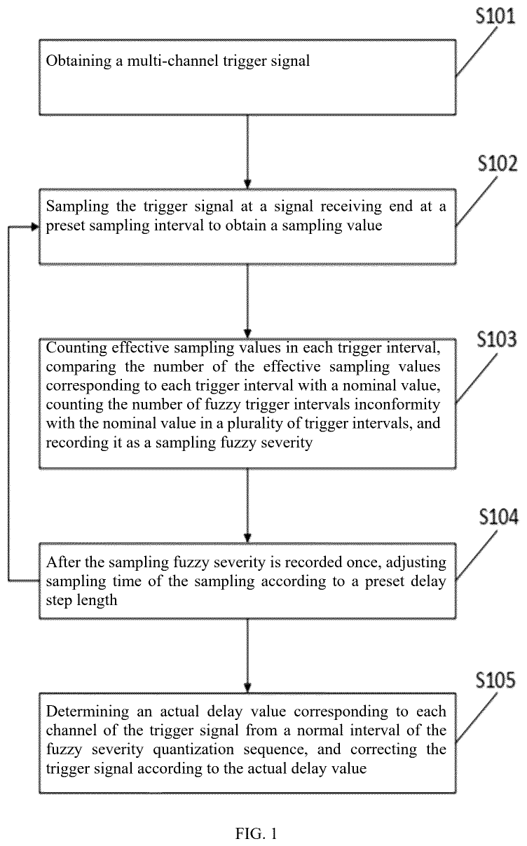

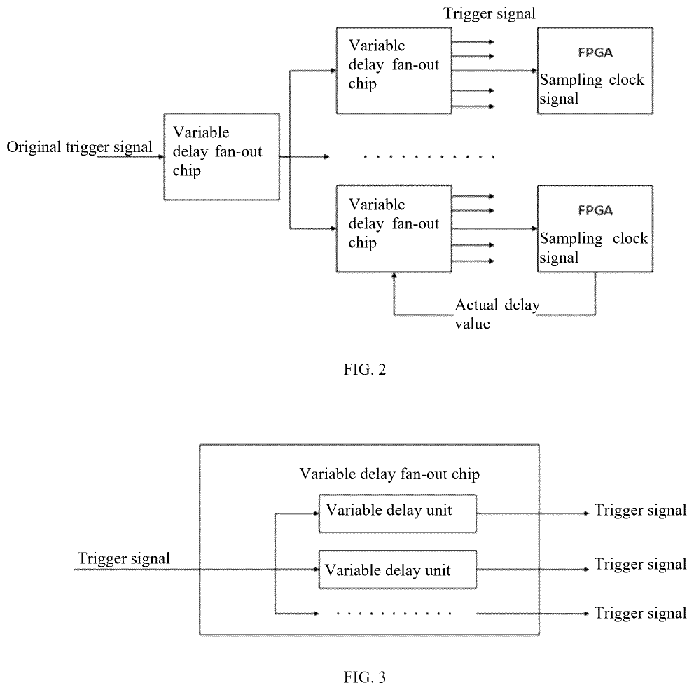

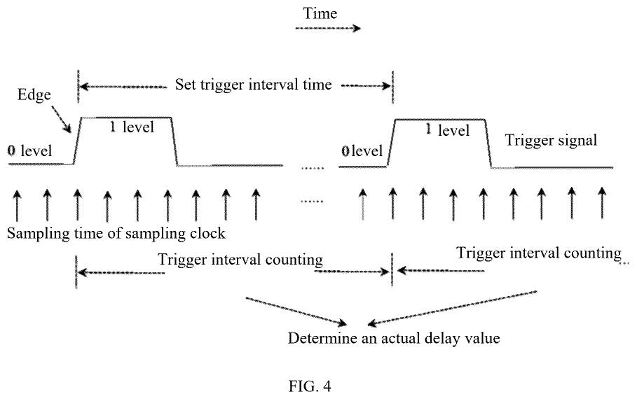

With reference to FIGS. 1 to 4, FIG. 1 is a flow diagram of a quantum bit control signal delay calibration method provided by an embodiment of the present disclosure; FIG. 2 is a structural diagram of the system corresponding to FIG. 1; FIG. 3 is a schematic structural diagram of a variable delay fan-out chip of FIG. 2; and FIG. 4 is a schematic diagram of the principle corresponding to FIG. 1.

Referring to FIG. 1, in an embodiment of the present disclosure, a quantum bit control signal delay calibration method comprises:

S101: obtaining a multi-channel trigger signal.

In the embodiment of the present disclosure, the trigger signal is a trigger signal sent to a quantum chip, the trigger signal being a signal sent sequentially according to a uniform trigger interval. That is, the multi-channel trigger signal obtained in this step is specifically a multi-channel trigger signal divided by the same original trigger signal, and the trigger signal is a continuously transmitted signal and has a uniform trigger interval., i.e., in the same signal channel, the trigger signals acquired at two adjacent times have the same interval. The above trigger interval is an interval sent by the trigger signal, i.e., the interval between two adjacent transitions from level 0 to level 1 or from level 1 to level 0 of the same trigger signal.

Referring to FIGS. 2 and 3, specifically, in the embodiment of the present disclosure, the original trigger signals can be divided into multi-channel trigger signals through one or more variable delay fan-out chips, so that the acquisition of the multi-channel trigger signals is realized in the step. The variable delay fan-out chip usually includes a plurality of variable delay units inside. After the original trigger signal enters the variable delay fan-out chip, one input original trigger signal is divided into multi-channel trigger signals through a BUF (buffer) circuit. Each channel of trigger signal passes through the variable delay unit, so that the delay of each trigger signal can be adjusted based on the variable delay unit. When a plurality of variable delay fan-out chips are adopted, the plurality of variable delay fan-out chips can be connected in a tree-shaped distribution, i.e., the output of the variable delay fan-out chip in the previous stage is taken as the input of the variable delay fan-out chip in the next stage, and the required number of multi-channel trigger signals is obtained through the connection of the multi-stage variable delay fan-out chip. The specific structure and the specific connection relationship of the variable delay fan-out chip can be arranged according to actual conditions, which are not specifically limited herein.

S102: sampling the trigger signal at a signal receiving end at a preset sampling interval to obtain a sampling value.

Referring to FIG. 4, in an embodiment of the present disclosure, the trigger interval is an integral multiple of the sampling interval. In the embodiment, in a trigger interval, the trigger signal in the trigger interval is sampled multiple times. The sampling process has sampling intervals, and the trigger signal is sampled every sampling interval. Generally, the above sampling interval is a constant value. In the embodiment, the trigger interval is specifically an integer multiple of the sampling interval to ensure the uniformity of sampling times within a trigger interval. In this step, the sampling value generated by each sampling can be obtained. It should be noted that the sampling value can be any value between 0 and 1, including 0 and 1. When the sampling value is 0 or 1, it means that the sampling point corresponding to the sampling value does not fall on the edge of the trigger signal transition, and no sampling ambiguity occurs; and when the sampling value is not 0 or 1, it means that the sampling point corresponding to the sampling value falls on the edge of the trigger signal transition, resulting in the problem of sampling ambiguity. The so-called sampling ambiguity means that the sampling value is not 0 or 1, and at this time, the signal finally generated based on the sampling value may be 0 or 1, which is not an accurate value, and thus the sampling ambiguity occurs.

The sampling end may be specifically an FPGA, and the sampling process may be specifically performed in an FPGA, i.e., in the embodiment, each channel of trigger signal will be connected to an FPGA, and the trigger signal is sampled by a sampling clock signal in the FPGA, so that the FPGA can realize nanosecond level sampling and improve the speed of signal correction.

S103: counting effective sampling values in each trigger interval, comparing the number of the effective sampling values corresponding to each trigger interval with a nominal value, counting the number of fuzzy trigger intervals inconformity with the nominal value in a plurality of trigger intervals, and recording it as a sampling fuzzy severity.

In this embodiment, the above effective sampling value means that no sampling ambiguity occurs, and the sampling value is a value of 0 or 1. In this step, the number of effective sampling values in each trigger interval will be counted, and the number will be compared with a nominal value. The number of fuzzy trigger intervals inconformity with the nominal value in a plurality of trigger intervals will be counted and recorded as a sampling fuzzy severity.

The nominal value is a preset constant value for determining whether a trigger interval is a fuzzy trigger interval. Normally, for a trigger interval, the number of effective sampling values in the trigger interval will be compared with the nominal value. Specifically, the trigger interval with the number greater than or equal to the nominal value is recorded as a normal trigger interval, and the counted trigger interval with the number smaller than the nominal value is recorded as a fuzzy trigger interval.

The specific value of the above nominal value can be set according to actual situations. In the embodiment of the present disclosure, the nominal value can be specifically equal to the number of times of sampling in the trigger interval, i.e., the nominal value may be equal to the trigger interval being a multiple of the sampling interval. At this time, when the nominal value is specifically equal to the number of times of sampling in the trigger interval, it means that the trigger interval is recorded as a normal trigger interval only if no sampling ambiguity occurs in the sampling interval and each sampling value is 0 or 1. When sampling ambiguity occurs and the sampling value is neither 0 nor 1, the trigger interval is recorded as a fuzzy trigger interval. Certainly, the above nominal value can also be determined according to other standards, which is not specifically limited herein.

In this step, after the fuzzy trigger interval is marked, the number of fuzzy trigger intervals in a plurality of continuous trigger intervals is counted, and the number of the fuzzy trigger intervals is recorded as a sampling fuzzy severity.

S104: after the sampling fuzzy severity is recorded once, adjusting sampling time of the sampling according to a preset delay step length.

In the embodiment of the present disclosure, it is necessary to circularly execute the steps from sampling the trigger signal at the signal receiving end at a preset sampling interval to adjusting the sampling time according to the preset delay step length, i.e., to cycle the steps of S102 to S104 to obtain the sampling fuzzy severity corresponding to a plurality of delay values and generate a fuzzy severity quantization sequence.

In this embodiment, the sampling time is usually adjusted based on a unified delay step length. Adjusting the sampling time of the sampling according to the preset delay step length is equivalent to adjusting the position of the sampling point falling on the trigger signal, thereby changing the number of sampling ambiguity occurring when the sampling point falls on the edge of the trigger signal, ultimately altering the specific value of the sampling fuzzy severity, and generating a plurality of fuzzy severity quantization sequences with the sampling fuzzy severity arranged in sequence. The fuzzy severity quantification sequence is usually ordered according to the delay value, which is generally specified as the sum of the delay step lengths currently experienced at the time of recording.

S105: determining an actual delay value corresponding to each channel of the trigger signal from a normal interval of the fuzzy severity quantization sequence, and correcting the trigger signal according to the actual delay value.

When the sampling time is adjusted according to the delay step length, the finally generated fuzzy severity quantization sequence will produce a normal interval and a deterioration interval, wherein the deterioration interval is usually a section of peak intervals, indicating that within the delay value range, the sampling signal will produce obvious sampling ambiguity, and the sampling point will fall on the edge of the trigger signal. The normal interval is usually a gentle interval with low data, indicating that within the delay value range, the sampling signal will not produce obvious sampling ambiguity and the sampling point will not fall on the edge of the trigger signal. In the actual situation, the sampling fuzzy severity in the fuzzy severity quantization sequence will be displayed as the alternation of the deterioration interval and the normal interval as the delay value increases. In this step, a section of normal interval will be determined firstly, and then an actual delay value corresponding to each channel of trigger signal will be determined in the normal interval, so that the trigger signal is corrected according to the actual delay value to solve the problem of sampling ambiguity.

Specifically, in this embodiment, when the variable delay fan-out chip is used to output the multi-channel trigger signal, the step specifically includes: solidifying the actual delay value to the variable delay fan-out chip, and correcting the trigger signal, i.e., correcting each channel of the trigger signal by solidifying the calculated actual delay value to the variable delay fan-out chip.

In the quantum bit control signal delay calibration method provided by the embodiment of the present disclosure, after sampling a trigger signal having a fixed trigger interval based on a fixed sampling interval, an effective sampling value in each trigger interval is firstly counted, the number of fuzzy trigger intervals is counted, and recorded as a sampling fuzzy severity; then the delay of the sampling signal is adjusted, and a fuzzy severity quantization sequence is generated based on the recorded sampling fuzzy severity under each delay, thus determining an actual delay value corresponding to each channel of the trigger signal, and correcting the trigger signal. In the process of adjusting the delay of the sampling signal, it will inevitably sweep over the edge of the trigger signal, and thus will inevitably undergo a process of “deterioration-normal-deterioration-normal” or “normal-deterioration-normal-deterioration”. In the above process, the actual delay value corresponding to each channel of trigger signal is determined from the normal interval of the fuzzy severity quantization sequence, so that the occurrence of the sampling ambiguity can be effectively avoided, and the accuracy of multi-channel sampling signals can be effectively improved.

The process includes counting the number of fuzzy trigger intervals inconformity with the nominal value in a plurality of trigger intervals, and recording it as a sampling fuzzy severity; and further obtaining the sampling fuzzy severity corresponding to a plurality of delay values through delay, and generating a fuzzy severity quantization sequence. By referring to the specific conditions of a plurality of trigger interval, it will be possible to minimise accuracy problems caused by measurement errors or operational errors from a statistical point of view. Meanwhile, the fuzzy severity quantization sequence obtained by further measuring the sampling fuzzy severity can accurately reflect the real condition of the measurement signal channel, so as to obtain a more accurate actual delay value, effectively avoid the occurrence of the sampling fuzzy, and effectively improve the accuracy of multi-channel sampling signals.

The specific contents of a quantum bit control signal delay calibration method provided by the present disclosure will be described in detail in the following embodiments of the present disclosure.

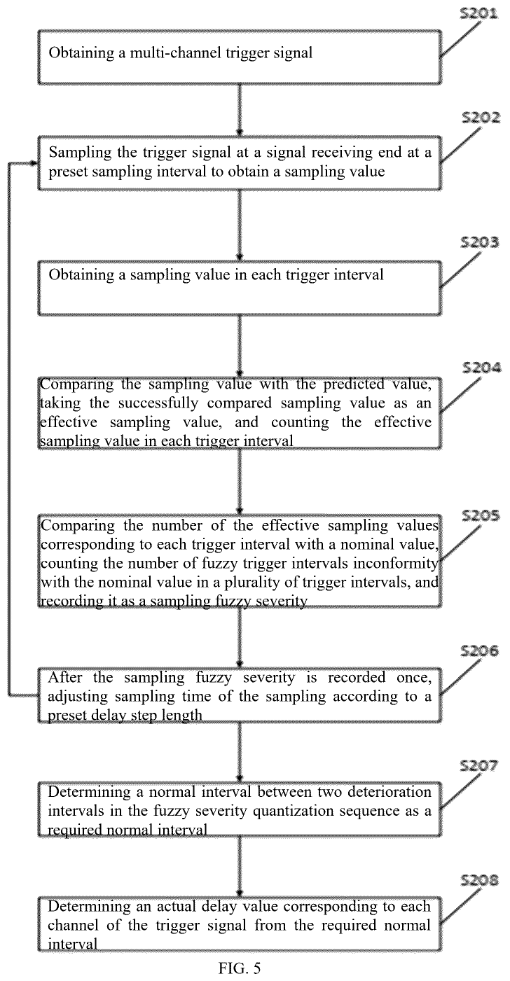

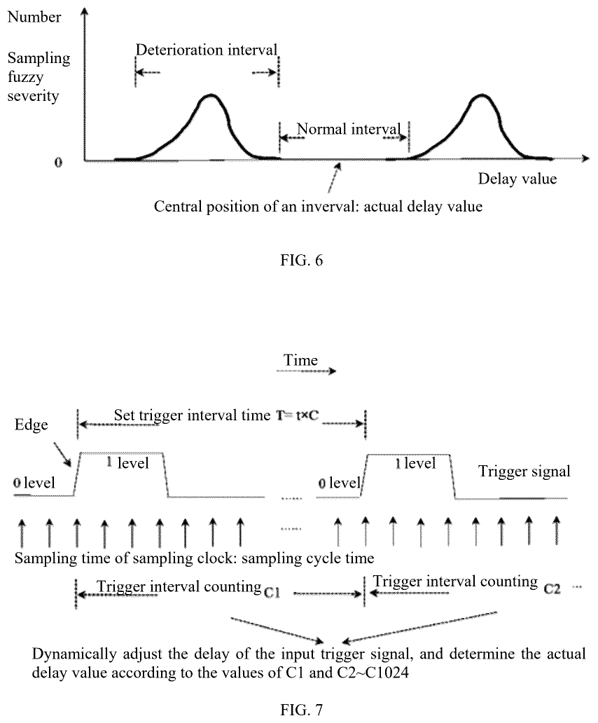

With reference to FIGS. 5 to 6, FIG. 5 is a flow diagram of a specific quantum bit control signal delay calibration method provided by an embodiment of the present disclosure; and FIG. 6 is a schematic diagram of a fuzzy severity quantization sequence.

Referring to FIG. 5, in an embodiment of the present disclosure, a quantum bit control signal delay calibration method comprises:

S201: obtaining a multi-channel trigger signal.

S202: sampling the trigger signal at a signal receiving end at a preset sampling interval to obtain a sampling value.

The above S201 and S202 are basically the same as S101 and S102 in the above embodiment of the present disclosure. Please refer to the above embodiment of the present disclosure for details, and the detailed description will not be repeated herein.

S203: obtaining a sampling value in each trigger interval.

In this step, the sample values within each trigger interval will specifically be determined.

S204: comparing the sampling value with the predicted value, taking the successfully compared sampling value as an effective sampling value, and counting the effective sampling value in each trigger interval.

In the embodiment of the present disclosure, the sampling value which is not successfully compared is a sampling value obtained by sampling the edge of the trigger signal. The above prediction value may specifically be an array including 0 and 1. When the comparison is successful, it means that the sampling value is 0 or 1, the sampling point corresponding to the sampling value falls in a high-level position or a low-level position, and does not fall on the edge of the trigger signal transition, which is recorded as an effective sampling value. When the comparison is unsuccessful, it means that the sampling value is neither 0 nor 1, the sampling point corresponding to the sampling value falls on the edge of the trigger signal transition, and is not counted as an effective sampling value. In this step, the effective sample value in each trigger interval will be counted.

S205: comparing the number of the effective sampling values corresponding to each trigger interval with a nominal value, counting the number of fuzzy trigger intervals inconformity with the nominal value in a plurality of trigger intervals, and recording it as a sampling fuzzy severity.

The specific contents of the above S205 have been described in detail in S103 of the above embodiment of the present disclosure, and will not be described in detail herein. In this step, when the nominal value is equal to the number of times of sampling in the trigger interval, the trigger interval in which the sampling ambiguity exists is specifically recorded as a fuzzy trigger interval, and then the number of consecutive trigger intervals recorded as the fuzzy trigger interval is counted, for example, counting the number of 1024 consecutive trigger intervals recorded as fuzzy trigger intervals, i.e., the trigger intervals where sampling ambiguity exists, e.g., 100, the 100 will be recorded as a sampling ambiguity severity.

S206: after the sampling fuzzy severity is recorded once, adjusting sampling time of the sampling according to a preset delay step length.

In the embodiment of the present disclosure, it is necessary to circularly execute the steps from sampling the trigger signal at the signal receiving end at a preset sampling interval to delaying the sampling time according to the preset delay step length, i.e., to cycle the steps from S202 to S206 until the current delay value is equal to the sampling interval to obtain the sampling fuzzy severity corresponding to a plurality of delay values and generate a fuzzy severity quantization sequence.

That is, in this step, the termination condition of the cycling is that the current delay value is equal to the sampling interval, and the gradual delay for the sampling is equivalent to the delay for the sampling point. However, in this embodiment, for the delay of the sampling point, there is a cut-off until the positions of the sampling points before and after the delay are overlapped, i.e., the span of the delay is one sampling period. At this time, the continuous delay of the sampling according to the delay step length will be terminated, and a fuzzy severity quantization sequence is generated based on the acquired plurality of sampling fuzzy severities.

The rest of this step is basically the same as S104 in the above embodiment of the present disclosure. Please refer to the above embodiment of the present disclosure for details, and the detailed description will not be repeated herein.

S207: determining a normal interval between two deterioration intervals in the fuzzy severity quantization sequence as a required normal interval.

In the present embodiment, the sampling fuzzy severity corresponding to the delay value in the deterioration interval is greater than a standard value, and the sampling fuzzy severity corresponding to the delay value in the normal interval is not greater than a standard value.

When the cut-off condition of the cycling is determined as the current delay value being equal to the sampling interval, a schematic diagram corresponding to the fuzzy severity quantization sequence is shown in FIG. 6, it will inevitably undergo the process of “deterioration-normal-deterioration-normal” or “normal-deterioration-normal-deterioration” since the span of the delay is one sampling period. In order to obtain an accurate actual delay value, the normal interval between the two deterioration intervals is specifically determined as the required normal interval in this step.

S208: determining an actual delay value corresponding to each channel of the trigger signal from the required normal interval.

In this step, the actual delay value corresponding to each trigger signal of the interval will be specifically determined according to the required normal interval between the two deterioration intervals, so as to correct the trigger signal according to the actual delay value.

Specifically, the step may include selecting the delay value closest to the central position in the required normal interval as the actual delay value, i.e., selecting the delay value closest to the central position in the required normal interval as the actual delay value, and in the fuzzy severity quantization sequence, margins are reserved on both sides of the actual delay value, ensuring that sampling ambiguity does not arise, thereby achieving synchronous triggering of multiple use ends.

The embodiment of the present disclosure provides a quantum bit control signal delay calibration method. The process includes counting the number of fuzzy trigger intervals inconformity with the nominal value in a plurality of trigger intervals, and recording it as a sampling fuzzy severity; and further obtaining the sampling fuzzy severity corresponding to a plurality of delay values through delay, and generating a fuzzy severity quantization sequence. By referring to the specific conditions of a plurality of trigger interval, it will be possible to minimise accuracy problems caused by measurement errors or operational errors from a statistical point of view. Meanwhile, the fuzzy severity quantization sequence obtained by further measuring the sampling fuzzy severity can accurately reflect the real condition of the measurement signal channel, so as to obtain a more accurate actual delay value, effectively avoid the occurrence of the sampling fuzzy, and effectively improve the accuracy of multi-channel sampling signals.

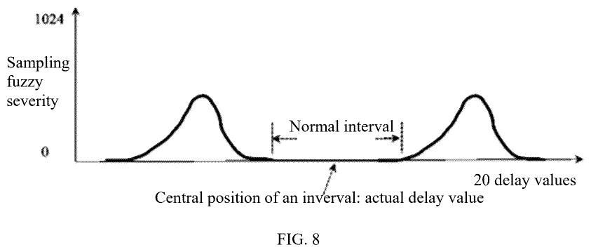

With reference to FIGS. 7 to 8, FIG. 7 is a schematic diagram of a specific principle provided by an embodiment of the present disclosure, and FIG. 8 is a schematic diagram of a specific fuzzy severity quantization sequence provided by an embodiment of the present disclosure.

An example of the implementation process of a quantum bit control signal delay calibration method provided by the present disclosure will be described below.

First, for the input original trigger signal, in this embodiment, a multi-channel trigger signal is generated by a variable delay fan-out chip. At this stage, a variable delay fan-out chip generates at most 14 trigger signals, and the delay of each channel of trigger signal is independently adjustable. When the number of use ends exceeds 14, the variable delay fan-out chip can be further connected in series to expand more trigger signals, which is suitable for the control requirements with increasing number of bits.

The variable delay fan-out chip can firstly divide the input original trigger signal into multiple channels through a BUF circuit, and then adjust the delay through the variable delay unit inside the chip, wherein each channel can adjust the delay independently, and the time step of the adjustment is 25 ps, i.e., the delay step length is 25 ps. This adjustment does not affect the period and shape of the trigger signal. Since a single variable delay fan-out chip can output 14 channels of trigger signals, hundreds of channels of trigger signals can be expanded through multi-chip interconnection, so that it is convenient to perform triggering operations on control signals with a large number of channels at low implementation cost in the superconducting quantum bit control application.

The trigger signal after variable delay enters the FPGA of the user end, each FPGA only needs one channel of trigger signal, and the trigger signal is sampled using a sampling clock in the FPGA. The sampling period is set as t. Generally, the sampling clock is 250 MHz and the corresponding sampling period is t=4 ns.

In this embodiment, the trigger interval of the original trigger signal is set as T, T being configured as an integral multiple of t, and the multiple is set as C (nominal value). In this embodiment, the nominal value C may take a value of 1000, and the trigger interval time is 4 ns×1000=4000 ns.

Referring to FIG. 7, the trigger signal is sampled in the FPGA at the receiving end, and the number of sampling points between two adjacent triggers is counted in each trigger interval. That is, the number of sampling points in one trigger interval is counted and set as Cx, and 1024 trigger intervals are counted each time and the statistical values are set as C1, C2, . . . , and C1024, respectively. When the sampling clock samples the edge of the trigger signal, its specific sampling value is neither “0 level” or “1 level”, and it may finally sample “0 level” or “1 level”, i.e., the sampling ambiguity problem occurs, causing Cx not to be equal to the nominal value C. In the embodiment, the trigger delay is dynamically adjusted according to C1, C2, . . . . C1024 to find out the optimal delay configuration, and solidified to the delay configuration of the corresponding channel in the “variable delay fan-out” chip, to complete the automatic calibration of the trigger ambiguity. Each channel is calibrated independently, and the automatic calibration of each channel only takes 100 ms, with extremely fast calibration speed.

Specifically, in this embodiment, the counted count sequences C1, C2, . . . . C1024 will usually take values between (1000−2) and (1000+2). If all of these 1024 values are equal to 1000, the nominal value, in a single count, it is considered correctly sampled. Through the fixed interval triggering and sampling statistics technology, it is possible to efficiently identify whether there is a sampling ambiguity in the trigger signal, which provides the basis for the subsequent delay adjustment.

In this embodiment, the severity of the sampling ambiguity is identified according to the quantized sampling statistics. The more serious the ambiguity is, the more the number of corresponding C1, C2 . . . C1024 sequences that are not equal to the nominal value (nominal value C is 1000 in this embodiment) is, and the greater the corresponding value of the sampling fuzzy severity calculated in this embodiment is. Theoretically, the most serious ambiguity occurs when the sampling time is exactly at the middle position of the edge of the trigger signal.

Referring to FIG. 8, in this embodiment, the trigger signal is configured to be delayed at equal intervals of 200 ps in one sampling period (4 ns in this embodiment), i.e., the delay step length is 200 ps. At this time, there is a total of 20 delay states. In each delay state, the number of values in C1, C2, . . . C1024 that are not equal to the nominal value is counted and set as a sampling fuzzy severity K, so as to form a fuzzy severity quantization sequence including the 20 values from K1 to K20. Each value in the fuzzy severity quantification sequence corresponds to a fuzzy severity in the range of 4 ns. Since the span is a sampling period, it will inevitably undergo the process of “deterioration-normal-deterioration-normal” or “normal-deterioration-normal-deterioration”, as shown in FIG. 4. In this embodiment, specifically, one delay value closest to the center position of the interval is selected as the actual delay value in a normal interval (no sampling ambiguity) between the two deterioration intervals, and margins are reserved on both sides, ensuring that sampling ambiguity does not arise, thereby achieving synchronous triggering of multiple use ends.

A quantum bit control signal delay calibration device provided by an embodiment of the present disclosure is described below. The quantum bit control signal delay calibration device described below and the quantum bit control signal delay calibration method described above may be correspondingly referred to each other.

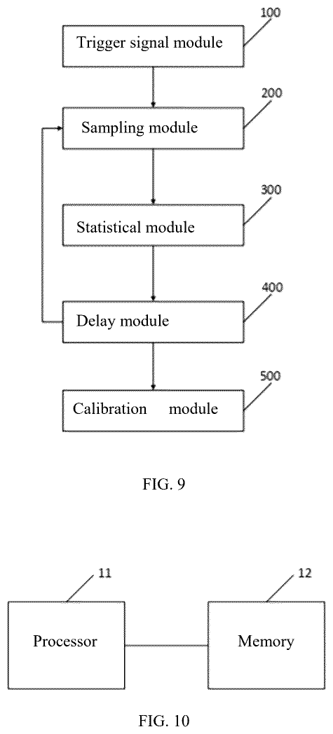

With reference to FIG. 9, FIG. 9 is a structural block diagram of a quantum bit control signal delay calibration device provided by an embodiment of the present disclosure.

Referring to FIG. 9, in the embodiment of the present disclosure, a quantum bit control signal delay calibration device may comprise:
a trigger signal module 100 for obtaining a multi-channel trigger signal; the trigger signal being a signal sent sequentially according to a uniform trigger interval;
a sampling module 200 sampling the trigger signal at a signal receiving end at a preset sampling interval to obtain a sampling value; the trigger interval being an integral multiple of the sampling interval;
a statistical module 300 for counting effective sampling values in each trigger interval, comparing the number of the effective sampling values corresponding to each trigger interval with a nominal value, counting the number of a fuzzy trigger interval inconformity with the nominal value in a plurality of trigger intervals, and recording it as a sampling fuzzy severity;
a delay module 400 for adjusting sampling time of the sampling according to a preset delay step length after the sampling fuzzy severity is recorded once, circularly operating the sampling module to the delay module to obtain the sampling fuzzy severity corresponding to a plurality of delay values, and generating a fuzzy severity quantization sequence; and
a calibration module 500 for determining an actual delay value corresponding to each channel of the trigger signal from a normal interval of the fuzzy severity quantization sequence, and correcting the trigger signal according to the actual delay value.

In the embodiment of the present disclosure, the trigger signal module 100 is used for:
obtaining a multi-channel trigger signal output by a variable delay fan-out chip based on an original trigger signal.

The calibration module 500 is used for:
solidifying the actual delay value to the variable delay fan-out chip, and correcting the trigger signal.

In the embodiment of the present disclosure, the nominal value is equal to the number of samples in the trigger interval.

In the embodiment of the present disclosure, the statistical module 300 includes:
a sampling value acquisition unit for obtaining a sampling value in each trigger interval; and
a sampling value comparison unit for comparing the sampling value with the predicted value, taking the successfully compared sampling value as an effective sampling value, and counting the effective sampling value in each trigger interval; the sampling value which is not successfully compared being a sampling value obtained by sampling an edge of the trigger signal.

In the embodiment of the present disclosure, the delay module 400 is used for:
delaying the sampling time of the sampling according to the preset delay step length, circularly operating the sampling module 200 to the delay module 400 until the current delay value is equal to the sampling interval, to obtain the sampling fuzzy severity corresponding to a plurality of delay values, and generating a fuzzy severity quantization sequence.

In the embodiment of the present disclosure, the calibration module 500 includes:
a required normal interval unit for determining a normal interval between two deterioration intervals in the fuzzy severity quantization sequence as a required normal interval; the sampling fuzzy severity corresponding to the delay value in the deterioration interval being greater than a standard value, and the sampling fuzzy severity corresponding to the delay value in the normal interval being not greater than a standard value; and
an actual delay value unit for determining an actual delay value corresponding to each channel of the trigger signal from the required normal interval.

In the embodiment of the present disclosure, the actual delay value unit is used for:
selecting the delay value closest to the central position in the required normal interval as the actual delay value.

The quantum bit control signal delay calibration device of this embodiment is used to implement the above quantum bit control signal delay calibration method. Therefore, the specific implementation in the quantum bit control signal delay calibration device can be referred to the embodiment part of the quantum bit control signal delay calibration method described above. For example, the trigger signal module 100, the sampling module 200, the statistical module 300, the delay module 400, and the calibration module 500 are used to implement steps S101 to S105, respectively, of the above quantum bit control signal delay calibration method. Therefore, the specific embodiment thereof can be referred to the description of the corresponding embodiment of the each part, and the detailed description is omitted herein.

A quantum bit control signal delay calibration equipment provided by an embodiment of the present disclosure is described below. The quantum bit control signal delay calibration equipment described below and the quantum bit control signal delay calibration method and the quantum bit control signal delay calibration device described above may be correspondingly referred to each other.

With reference to FIG. 10, FIG. 10 is a structural block diagram of a quantum bit control signal delay calibration equipment provided by an embodiment of the present disclosure.

Referring to FIG. 10, the quantum bit control signal delay calibration equipment may comprise: a processor 11 and a memory 12.

A memory 12 is used for storing a computer program, and a processor 11 is used for implementing the steps of a quantum bit control signal delay calibration method according to the above embodiment of the present disclosure when executing the computer program.

In the quantum bit control signal delay calibration equipment of this embodiment, the processor 11 is configured to install the quantum bit control signal delay calibration device described in the embodiment of the present disclosure, and the processor 11 is combined with the memory 12 to implement the quantum bit control signal delay calibration method described in any one of the embodiments of the present disclosure. The specific implementation in the quantum bit control signal delay calibration equipment can be referred to the embodiment part of the quantum bit control signal delay calibration method described above. Therefore, the specific embodiment thereof can be referred to the description of the corresponding embodiment of the each part, and the detailed description is omitted herein.

The present disclosure further provides a computer-readable storage medium, and the computer-readable storage medium has a computer program stored thereon, the computer program being executed by a processor to implement the steps of a quantum bit control signal delay calibration method according to any one of the embodiment of the present disclosure. The rest of the contents can be referred to the prior art and will not be described herein.

Each embodiment in the specification is described in a progressive manner, each embodiment focuses on the differences from other embodiments, and the same or similar parts among the embodiments can be referred to each other. For the device disclosed in the embodiments, the description thereof is relatively simple since it corresponds to the method disclosed in the embodiments. For the relevant information, please refer to the description of the method.

Those skilled in the art may further realize that the units and algorithmic steps of the examples described in conjunction with the embodiments disclosed herein can be implemented in electronic hardware, computer software, or a combination thereof. To clearly illustrate the interchangeability of hardware and software, the components and steps of the examples have been described generally in terms of function in the above description. Whether these functions are performed in hardware or software depends on the particular application and design constraints of the technical solution. Those skilled in the art may use different methods to implement the described functions for each particular application, but such implementations should not be considered as going beyond the scope of the present disclosure.

The steps of the methods or algorithms described in conjunction with the embodiments disclosed herein may be implemented directly with hardware, a software module executed by a processor, or a combination thereof. A software module may be placed in random access memory (RAM), memory, read-only memory (ROM), electrically programmable ROM, electrically erasable programmable ROM, a register, a hard disk, a removable diskette, a CD-ROM, or any other form of storage medium known in the art.

Finally, it should also be noted that relationship terms such as first and second, etc. are used herein only to distinguish one entity or operation from another without necessarily requiring or implying any such actual relationship or order between those entities or operations. Moreover, the terms “comprise”, “include” or any other variation thereof, are intended to cover a non-exclusive inclusion, such that a process, a method, an article, or an apparatus comprising a list of elements includes not only those elements, but also other elements not explicitly listed or may include elements inherent to the process, method, article, or apparatus. Without further limitation, an element defined by the statement of “comprising a . . . ” does not exclude the further presence of additionally identical elements in a process, a method, an article or an apparatus comprising said element.

A quantum bit control signal delay calibration method and related device are described in detail in the present disclosure. Specific examples are used herein to illustrate the principles and embodiments of the present disclosure, and the above description of the examples is merely intended to aid in the understanding of the methods of the present disclosure and the core concepts thereof. It should be noted that those skilled in the art can make several improvements and modifications to the present disclosure without departing from the principles of the present disclosure, and these improvements and modifications also fall within the protection scope of the claims of the present disclosure.

What is claimed is:

1. A quantum bit control signal delay calibration method, comprising:
obtaining a multi-channel trigger signal; the trigger signal being a signal sent sequentially according to a uniform trigger interval;
sampling the trigger signal at a signal receiving end at a preset sampling interval to obtain a sampling value; the trigger interval being an integral multiple of the sampling interval;
counting effective sampling values in each trigger interval, comparing the number of the effective sampling values corresponding to each trigger interval with a nominal value, counting the number of fuzzy trigger intervals inconformity with the nominal value in a plurality of trigger intervals, and recording it as a sampling fuzzy severity;
after the sampling fuzzy severity is recorded once, adjusting sampling time of the sampling according to a preset delay step length, circularly executing the steps from sampling the trigger signal at the signal receiving end at a preset sampling interval to adjusting the sampling time according to the preset delay step length to obtain the sampling fuzzy severity corresponding to a plurality of delay values, and generating a fuzzy severity quantization sequence; and
determining an actual delay value corresponding to each channel of the trigger signal from a normal interval of the fuzzy severity quantization sequence, and correcting the trigger signal according to the actual delay value.

2. The method of claim 1, wherein obtaining a multi-channel trigger signal comprises:
obtaining a multi-channel trigger signal output by a variable delay fan-out chip based on an original trigger signal;
the step of correcting the trigger signal according to the actual delay value comprises:
solidifying the actual delay value to the variable delay fan-out chip, and correcting the trigger signal.

3. The method of claim 1, wherein the nominal value is equal to the number of samples in the trigger interval.

4. The method of claim 1, wherein counting effective sampling values in each trigger interval comprises:
obtaining a sampling value in each trigger interval; and
comparing the sampling value with the predicted value, taking the successfully compared sampling value as an effective sampling value, and counting the effective sampling value in each trigger interval; the sampling value which is not successfully compared being a sampling value obtained by sampling an edge of the trigger signal.

5. The method of claim 1, wherein adjusting sampling time of the sampling according to a preset delay step length, circularly executing the steps from sampling the trigger signal at the signal receiving end at a preset sampling interval to adjusting the sampling time according to the preset delay step length to obtain the sampling fuzzy severity corresponding to a plurality of delay values, and generating a fuzzy severity quantization sequence comprises:
delaying the sampling time of the sampling according to the preset delay step length, circularly executing the steps from sampling the trigger signal at the signal receiving end at a preset sampling interval to delaying the sampling time according to the preset delay step length until the current delay value is equal to the sampling interval, to obtain the sampling fuzzy severity corresponding to a plurality of delay values, and generating a fuzzy severity quantization sequence.

6. The method of claim 5, wherein determining an actual delay value corresponding to each channel of the trigger signal from a normal interval of the fuzzy severity quantization sequence comprises:
determining a normal interval between two deterioration intervals in the fuzzy severity quantization sequence as a required normal interval; the sampling fuzzy severity corresponding to the delay value in the deterioration interval being greater than a standard value, and the sampling fuzzy severity corresponding to the delay value in the normal interval being not greater than a standard value; and
determining an actual delay value corresponding to each channel of the trigger signal from the required normal interval.

7. The method of claim 6, wherein determining an actual delay value corresponding to each channel of the trigger signal from the required normal interval comprises:
selecting the delay value closest to the central position in the required normal interval as the actual delay value.

8. A quantum bit control signal delay calibration device, comprising:
a trigger signal module for obtaining a multi-channel trigger signal; the trigger signal being a signal sent sequentially according to a uniform trigger interval;
a sampling module sampling the trigger signal at a signal receiving end at a preset sampling interval to obtain a sampling value; the trigger interval being an integral multiple of the sampling interval;
a statistical module for counting effective sampling values in each trigger interval, comparing the number of the effective sampling values corresponding to each trigger interval with a nominal value, counting the number of a fuzzy trigger interval inconformity with the nominal value in a plurality of trigger intervals, and recording it as a sampling fuzzy severity;
a delay module for adjusting sampling time of the sampling according to a preset delay step length after the sampling fuzzy severity is recorded once, circularly operating the sampling module to the delay module to obtain the sampling fuzzy severity corresponding to a plurality of delay values, and generating a fuzzy severity quantization sequence; and
a calibration module for determining an actual delay value corresponding to each channel of the trigger signal from a normal interval of the fuzzy severity quantization sequence, and correcting the trigger signal according to the actual delay value.

9. A quantum bit control signal delay calibration equipment, comprising:
a memory for storing a computer program; and
a processor for implementing the steps of a quantum bit control signal delay calibration method as claimed in claim 1 when executing the computer program.
